(19) United States
(12) Patent Application Publication
(10) Pub. No.: US 2026/0330608 A1
(43) Pub. Date: Oct. 22, 2026

(54) IMAGE PROCESSING APPARATUS, IMAGE CAPTURING APPARATUS, IMAGE PROCESSING METHOD, AND STORAGE MEDIUM

(71) Applicant: CANON KABUSHIKI KAISHA, Tokyo (JP)

(72) Inventor: Kenji OUCHI, Tokyo (JP)

(21) Appl. No.: 19/630,587

(22) Filed: Mar. 27, 2026

(30) Foreign Application Priority Data
Apr. 17, 2025 (JP) 2025-068348

(51) Int. Cl. G06T 5/60; G06T 5/50; G06T 5/70; G06T 5/92; G06T 7/55

(52) U.S. Cl. CPC G06T 5/60; G06T 5/50; G06T 5/70; G06T 5/92; G06T 7/55; G06T 2207/20081

(57) ABSTRACT

There is provided an image processing apparatus. A generation unit generates a composite image by compositing a plurality of images. A selection unit selects one of a first noise reduction procedure and a second noise reduction procedure. The first noise reduction procedure executes noise reduction processing on each of the plurality of images before generation of the composite image. The second noise reduction procedure executes noise reduction processing on the composite image after generation of the composite image. A noise reduction unit executes one of the first noise reduction procedure and the second noise reduction procedure in accordance with a result of the selection.

### BACKGROUND

### Field of the Technology

The present disclosure relates to an image processing apparatus, an image capturing apparatus, an image processing method, and a storage medium.

### Description of the Related Art

A method is known in which a plurality of images are composited in accordance with an intended purpose to generate a composite image that is different from a single shot image. For example, high dynamic range (HDR) compositing that is intended to generate an image with an extended dynamic range is known as such a method.

Japanese Patent Laid-Open No. 2013-240031 discloses HDR compositing, and development processing for performing gamma conversion to make the luminance levels of a plurality of images uniform is executed therein. At this time, parameters of noise reduction (NR) processing are set in accordance with gamma characteristics.

In Japanese Patent Laid-Open No. 2013-240031, NR processing is executed with respect to each of a plurality of images before the plurality of images are composited. That is to say, in order to obtain one composite image, NR processing needs to be executed a plurality of times for the plurality of images, and this may take a relatively long processing time period. Therefore, it is not always appropriate to execute NR processing in the form disclosed in Japanese Patent Laid-Open No. 2013-240031.

### SUMMARY

The present disclosure provides, in at least some aspects thereof, a technique that makes it possible to select whether to execute NR processing before compositing or after compositing in a situation where a composite image is generated by compositing a plurality of images.

According to one aspect of the present disclosure, there is provided an image processing apparatus comprising at least one processor and/or at least one circuit which functions as: a generation unit configured to generate a composite image by compositing a plurality of images; a selection unit configured to select one of a first noise reduction procedure and a second noise reduction procedure, wherein the first noise reduction procedure executes noise reduction processing on each of the plurality of images before generation of the composite image, and the second noise reduction procedure executes noise reduction processing on the composite image after generation of the composite image; and a noise reduction unit configured to execute one of the first noise reduction procedure and the second noise reduction procedure in accordance with a result of the selection.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram showing a configuration of an image capturing apparatus 100 that functions as an image processing apparatus.

FIG. 2 is a flowchart showing image compositing processing executed by the image capturing apparatus 100 according to a first embodiment.

FIG. 3 is a flowchart showing image compositing processing executed by the image capturing apparatus 100 according to a second embodiment.

FIG. 4 is a conceptual diagram of processing for compositing two images that have been shot in a normal shooting mode under different exposure conditions.

FIG. 5 is a conceptual diagram of image compositing processing in a multi-shot NR mode.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

### <Configuration of Image Capturing Apparatus 100>

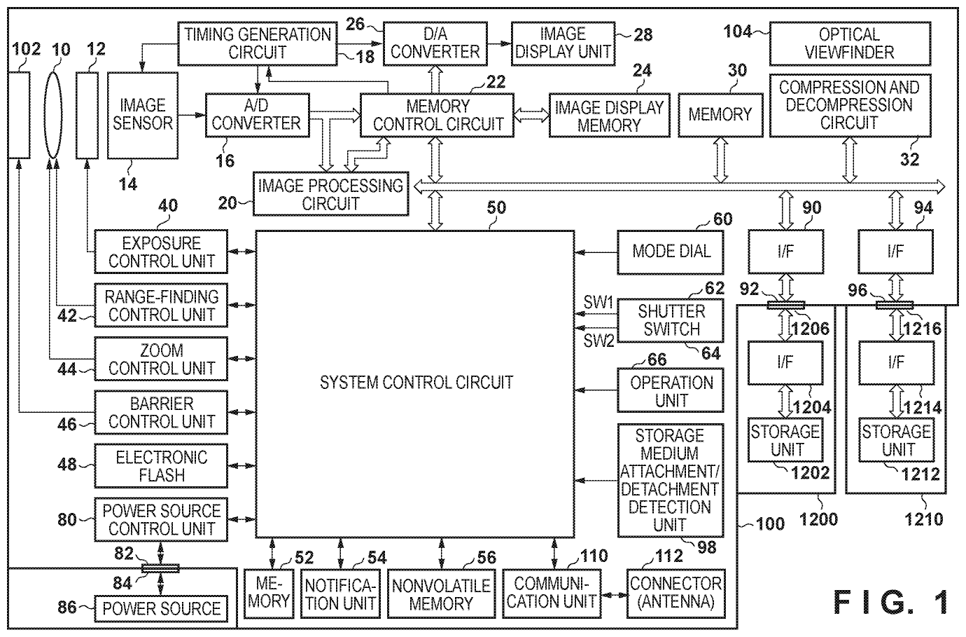

FIG. 1 is a diagram showing a configuration of an image capturing apparatus 100 that functions as an image processing apparatus. In FIG. 1, reference sign 10 denotes a shooting lens. Reference sign 12 denotes a shutter that has a diaphragm function. Reference sign 14 denotes an image sensor that converts an optical image of a subject into electrical signals. Reference sign 16 denotes an A/D converter that converts analog signals output from the image sensor 14 into digital signals.

Reference sign 18 denotes a timing generation circuit. The timing generation circuit 18 supplies clock signals and control signals to the image sensor 14, the A/D converter 16, and a D/A converter 26. The timing generation circuit 18 is controlled by a memory control circuit 22 and a system control circuit 50.

Reference sign 20 denotes an image processing circuit that executes predetermined pixel interpolation processing and color conversion processing with respect to data from the A/D converter 16 or data from the memory control circuit 22. Also, the image processing circuit 20 executes predetermined computation processing with use of image data that has been generated through image capture, and supplies a result of this computation to the system control circuit 50. The system control circuit 50 controls an exposure control unit 40 and a range-finding control unit 42 based on the computation result supplied from the image processing circuit 20. As a result, autofocus (AF) processing, automatic exposure (AE) processing, and preliminary flash emission (EF) processing of the through-the-lens (TTL) method are realized. Furthermore, the image processing circuit 20 also executes auto white balance (AWB) processing of the TTL method with use of image data generated through image capture. In addition, the image processing circuit 20 also executes image compositing processing.

Reference sign 22 denotes a memory control circuit that controls the A/D converter 16, the timing generation circuit 18, the image processing circuit 20, an image display memory 24, the D/A converter 26, a memory 30, and a compression and decompression circuit 32. Data output from the A/D converter 16 is supplied to the memory control circuit 22 via the image processing circuit 20, or is supplied directly to the memory control circuit 22. As a result, data output from the A/D converter 16 is written to the image display memory 24 or the memory 30.

Reference sign 24 denotes an image display memory. Reference sign 26 denotes a D/A converter. Reference sign 28 denotes an image display unit composed of a TFT-LCD or the like. Image data for display that has been written to the image display memory 24 is supplied to the image display unit 28 via the D/A converter 26, and as a result, an image is displayed on the image display unit 28. An electronic viewfinder function can be realized by displaying captured images on the image display unit 28 in succession. Also, a reproduction and display function and various types of display functions can be utilized with use of the image display unit 28. Furthermore, the image display unit 28 can arbitrarily turn ON/OFF the display in response to an instruction of the system control circuit 50, and when the display has been turned OFF, the power consumption of the image capturing apparatus 100 can be significantly reduced.

Reference sign 30 denotes a memory that stores still images and moving images that have been shot, as well as composite images that have been generated by the image processing circuit 20. The memory 30 has a storage capacity that is sufficient to store a predetermined number of still images and moving images of a predetermined time period. A large number of images can be saved at high speed by using this memory 30, even in the case of continuous shooting, in which a plurality of still images are continuously shot, or panorama shooting. Furthermore, the memory 30 can be used also as a working area for the system control circuit 50.

Reference sign 32 denotes a compression and decompression circuit that compresses or decompresses image data through, for example, an adaptive discrete cosine transform (ADCT). The compression and decompression circuit 32 reads in an image stored in the memory 30, executes compression processing or decompression processing, and writes data that has undergone the processing to the memory 30.

Reference sign 40 denotes an exposure control unit that controls the shutter 12, which has the diaphragm function, and can also perform flash light adjustment in coordination with an electronic flash 48. Reference sign 42 denotes a range-finding control unit that controls focusing of the shooting lens 10. The exposure control unit 40 and the range-finding control unit 42 are controlled by the system control circuit 50 based on a computation result obtained by the image processing circuit 20 computing image data generated through image capture. As a result, exposure control and range-finding control of the TTL method are realized.

Reference sign 44 denotes a zoom control unit that controls zooming of the shooting lens 10. Reference sign 46 denotes a barrier control unit that controls operations of a barrier 102 (protection unit).

Reference sign 48 denotes an electronic flash that has a function of projecting AF auxiliary light that is intended to facilitate focusing by irradiating a subject with bright light. Note that the electronic flash 48 may be configured as a single electronic flash, or may be provided with, for example, a plurality of xenon tubes for flash light emission, and LEDs for low-intensity long-duration emission and for video light, and controlled while switching among these at the time of main light emission.

Reference sign 50 denotes a system control circuit that controls the entire image capturing apparatus 100. Reference sign 52 denotes a memory that stores constants, variables, programs, and the like for operations of the system control circuit 50. Furthermore, the memory 52 also stores a program line chart used in AE. The program line chart is a table that defines a relationship between a diaphragm opening diameter and a control value of a shutter speed relative to an exposure value.

Reference sign 54 denotes a notification unit. The notification unit 54 notifies a user of an operational state, a message, and the like with use of, for example, characters, images, and sounds in response to execution of a program by the system control circuit 50. One or more notification units 54 are disposed at easy-to-view positions near operation units of the image capturing apparatus 100. For example, the notification unit 54 is composed of a combination of a liquid crystal display (LCD), an LED, a sound emitting element (e.g., a speaker), and the like. Also, a part of the notification unit 54 is disposed inside an optical viewfinder 104.

Among the notification contents of the notification unit 54, contents displayed on the LCD and the like include a single shot/continuous shooting display, a self-timer display, a compression ratio display, a display of the number of recorded pixels, a display of the number of recorded images, a display of the number of remaining images that can be shot, a shutter speed display, an f-number display, and so forth. Such contents also include an exposure correction display, a flash display, a red-eye reduction display, a macro shooting display, a buzzer setting display, a display of a remaining battery amount for a clock, a display of a remaining battery amount, an error display, an information display by a number denoted by two or more digits, a display of an attached/detached state of a storage medium 1200, a communication I/F operation display, a date and time display, and so forth.

Meanwhile, among the notification contents of the notification unit 54, contents displayed inside the optical viewfinder 104 include an in-focus display, a camera shake warning display, a flash charge display, a shutter speed display, an f-number display, an exposure correction display, and so forth.

Reference sign 56 denotes an electrically erasable and recordable nonvolatile memory, and is composed of, for example, an EEPROM and the like.

Reference signs 60, 62, 64, and 66 denote operation units that are intended for the user to issue instructions for various types of operations to the system control circuit 50, and are composed of, for example, one or more of switches, dials, touch panels, pointing apparatuses that use eye-gaze detection, voice recognition apparatuses, and the like.

Specifically, 60 is a mode dial. The mode dial 60 is used to switch among such modes as power-OFF, an automatic exposure mode like a program AE mode, a fully automatic mode, a manual exposure mode, a panorama shooting mode, a reproduction mode, a multi-screen reproduction/deletion mode, and a PC connection mode.

Reference sign 62 denotes a shutter switch (SW1). In the midst of an operation on a non-illustrated shutter button, the shutter switch 62 (SW1) is turned ON and issues an instruction for starting autofocus (AF) processing, automatic exposure (AE) processing, auto white balance (AWB) processing, preliminary flash emission (EF) processing, and the like.

Reference sign 64 denotes a shutter switch (SW2), and upon completion of an operation on the non-illustrated shutter button, the shutter switch 64 (SW2) is turned ON and issues an instruction for starting a sequence of processing including exposure processing, development processing, and recording processing. The exposure processing includes processing for writing signals that have been read out from the image sensor 14 as image data into the memory 30 via the A/D converter 16 and the memory control circuit 22. The development processing includes computation in the image processing circuit 20 and the memory control circuit 22. The recording processing includes processing for reading out image data from the memory 30, performing compression in the compression and decompression circuit 32, and writing the image data into the storage medium 1200.

Reference sign 66 denotes an operation unit composed of various types of buttons, a touch panel, and the like. The operation unit 66 includes a menu button, a set button, a macro button, an image display ON/OFF button, a multi-screen reproduction page-break button, a flash setting button, a button for switching among single shooting, continuous shooting, and self-timer, a menu transition + (plus) button, a menu transition − (minus) button, a reproduced image transition + (plus) button, a reproduced image transition − (minus) button, a shot image quality selection button, an exposure correction button, a date/time setting button, and so forth.

Reference sign 80 denotes a power source control unit, and is composed of a battery detection circuit, a DC-DC converter, a switch circuit that switches among blocks to which current flows, and the like. The power source control unit 80 detects whether a battery has been attached, a battery type, and a remaining battery amount, controls the DC-DC converter based on a detection result and an instruction of the system control circuit 50, and supplies a necessary voltage to each component, including a storage medium, for a necessary time period.

Reference signs 82 and 84 denote connectors. Reference sign 86 denotes a power source and is composed of, for example, a primary battery like an alkaline battery or a lithium battery, a secondary battery like a NiCd battery, a NiMH battery, or a Li battery, or an AC adapter.

Reference signs 90 and 94 denote interfaces with such storage mediums as a memory card or a hard disk. Reference signs 92 and 96 denote connectors for connecting to such storage mediums as a memory card or a hard disk. Reference sign 98 denotes a storage medium attachment/detachment detection unit that detects whether the storage mediums 1200 and 1210 are respectively attached to the connectors 92 and 96.

Note that the present embodiment is described under the assumption that the image capturing apparatus 100 has two systems that each include an interface and a connector for attachment of a storage medium. Needless to say, the number of systems that each include an interface and a connector for attachment of a storage medium may be one, or may be more than one. Also, it is permissible to adopt a configuration that includes a combination of interfaces and connectors of different standards. The interfaces and connectors may be configured using elements that conform to such standards as a PCMCIA card and a CompactFlash® card.

Furthermore, when the interfaces 90 and 94 and the connectors 92 and 96 are configured using elements that conform to such standards as a PCMCIA card and a CompactFlash^{®}card, various types of communication cards, such as a LAN card, a modem card, a USB card, an IEEE 1394 card, a P1284 card, an SCSI card, and a PHS card, can be connected to the connectors 92 and 96. In this way, the image capturing apparatus 100 and another computer or peripheral device (e.g., printer) can mutually transfer image data and management information attached to the image data.

Reference sign 102 denotes a barrier that covers an image capturing unit including the shooting lens 10 of the image capturing apparatus 100, thereby preventing the image capturing unit from becoming stained or damaged.

Reference sign 104 denotes an optical viewfinder. The user can perform shooting only with use of the optical viewfinder without using the electronic viewfinder function of the image display unit 28. Also, display members for realizing a part of the functions of the notification unit 54 (e.g., an in-focus display, a camera shake warning display, a flash charge display, a shutter speed display, an f-number display, an exposure correction display, and so forth) are disposed inside the optical viewfinder 104.

Reference sign 110 denotes a communication unit, and has various types of communication functions for RS-232C, USB, IEEE 1394, P1284, SCSI, modem, LAN, or wireless communication, for example.

Reference sign 112 denotes a connector (or an antenna in the case of wireless communication) that connects the image capturing apparatus 100 to another device via the communication unit 110.

Reference sign 1200 denotes a storage medium, such as a memory card or a hard disk. The storage medium 1200 includes a storage unit 1202 composed of, for example, a semiconductor memory or a magnetic disk, an interface 1204 with the image capturing apparatus 100, and a connector 1206 that connects to the image capturing apparatus 100.

Reference sign 1210 denotes a storage medium, such as a memory card or a hard disk. The storage medium 1210 includes a storage unit 1212 composed of, for example, a semiconductor memory or a magnetic disk, an interface 1214 with the image capturing apparatus 100, and a connector 1216 that connects to the image capturing apparatus 100.

### Examples of Shooting Modes

The image capturing apparatus 100 can shoot still images in a variety of shooting modes. Examples of the shooting modes include a normal shooting mode, an HDR mode, a multiple exposure mode, a focus bracket mode, a multi-shot NR mode, and so forth. The user can instruct the system control circuit 50 to set a shooting mode to a desired mode by operating the operation unit 66.

In the normal shooting mode, the system control circuit 50 shoots one image each time the user issues a shooting instruction. In this case, the system control circuit 50 determines a focusing distance and an exposure condition by executing AF processing and AE processing each time shooting is performed. Therefore, there are cases where at least one of the focusing distance and the exposure condition differs among a plurality of images that have been shot in the normal shooting mode.

The user can instruct the system control circuit 50 to composite a plurality of images that have been shot in the normal shooting mode with use of a desired method by operating the operation unit 66. Image compositing processing in the image capturing apparatus 100 is executed by the image processing circuit 20 in accordance with an instruction of the system control circuit 50. This is not limited to processing for compositing a plurality of images that have been shot in the normal shooting mode, and the same goes for, for example, image compositing processing in the later-described HDR mode.

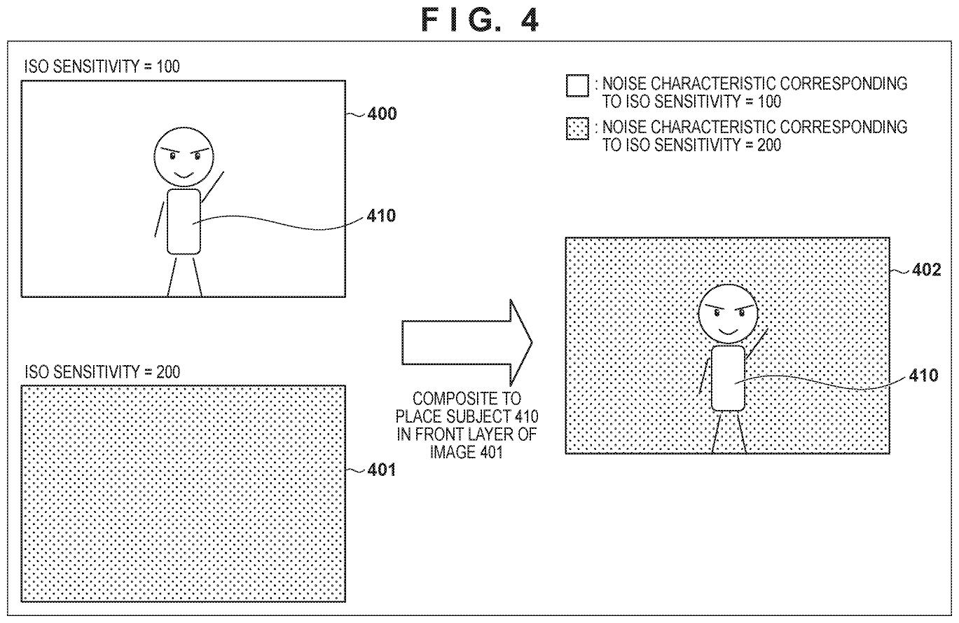

FIG. 4 is a conceptual diagram of processing for compositing two images that have been shot in the normal shooting mode under different exposure conditions. An image 400 is an image that has been shot under a first exposure condition (here, the ISO sensitivity=100), and includes a subject 410. An image 401 is an image that has been shot under an exposure condition (here, the ISO sensitivity=200) different from the first exposure condition, and does not include the subject 410. In the example of FIG. 4, it is assumed that compositing processing for bringing the subject 410 included in the image 400 to the front layer while using the image 401 as a background is executed. As a result, a composite image 402 is obtained. In the composite image 402, an area of the subject 410 originates from the image 400 that has been shot with the ISO sensitivity=100, and a background area originates from the image 401 that has been shot with the ISO sensitivity=200. In general, if the ISO sensitivity changes, then the noise characteristic will also change. Therefore, it is considered that the composite image 402 includes two areas with different noise characteristics.

In the HDR mode, the system control circuit 50 shoots a plurality of images with the same focusing distance under different exposure conditions in response to a shooting instruction of the user. For example, the system control circuit 50 shoots three images corresponding to underexposure, appropriate exposure, and overexposure. Then, the system control circuit 50 composites these three images with use of an image compositing method for extending a dynamic range. For example, the system control circuit 50 composites these three images in such a manner that an image with appropriate brightness is selected on an area-by-area basis. As a result, an image that includes little blown-out highlights and blocked-up shadows and has a wide dynamic range (an HDR image) is generated.

In the multiple exposure mode, the system control circuit 50 obtains a plurality of images corresponding to a plurality of shooting instructions by shooting one image each time the user issues a shooting instruction. In each shooting, the same exposure condition and the same focusing distance are used. The system control circuit 50 generates a multiple exposure image by compositing the plurality of images. Examples of compositing methods in the multiple exposure mode include “addition”, “addition and averaging”, “lighten compositing”, and “darken compositing”. “Addition” is a compositing method that sets, for each pixel in the multiple exposure image, a sum of pixel values of corresponding pixels in the plurality of images. “Addition and averaging” is a compositing method that sets, for each pixel in the multiple exposure image, an average value of pixel values of corresponding pixels in the plurality of images. “Lighten compositing” is a compositing method that sets, for each pixel in the multiple exposure image, a pixel value of the brightest pixel among corresponding pixels in the plurality of images. “Darken compositing” is a compositing method that sets, for each pixel in the multiple exposure image, a pixel value of the darkest pixel among corresponding pixels in the plurality of images.

In the focus bracket mode, the system control circuit 50 shoots a plurality of images under the same exposure condition with different focusing distances in response to a shooting instruction of the user. The system control circuit 50 generates a composite image that is in focus across a wide range by compositing the plurality of images in such a manner that an in-focus image is selected on an area-by-area basis. Such image compositing may be referred to as depth compositing. Also, a composite image generated through depth compositing may be referred to as a depth composite image.

In the multi-shot NR mode, the system control circuit 50 shoots a plurality of images under the same exposure condition with the same focusing distance in response to a shooting instruction of the user. The system control circuit 50 composites these plurality of images in equal proportion.

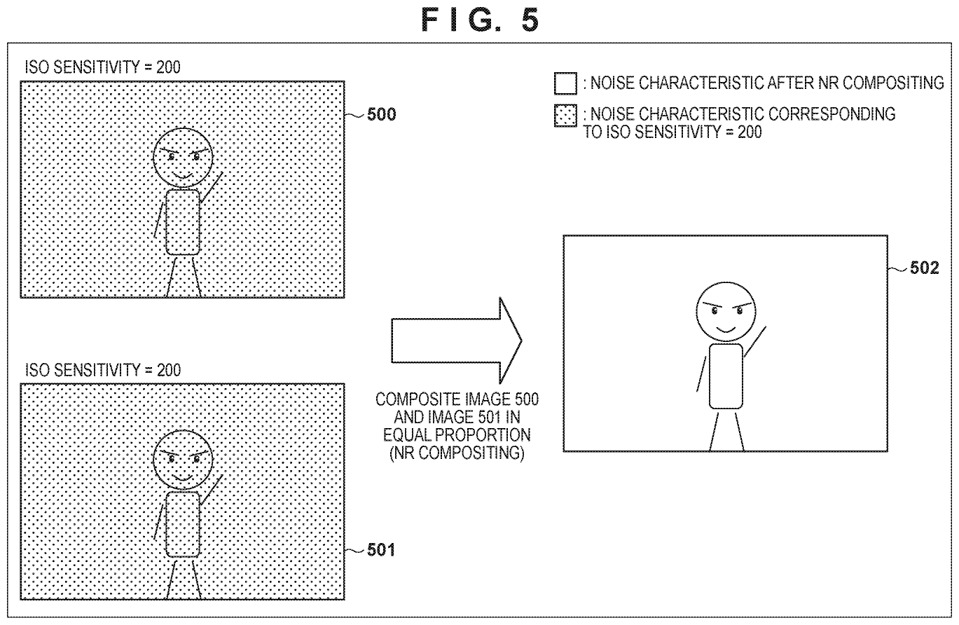

FIG. 5 is a conceptual diagram of image compositing processing in the multi-shot NR mode. In the example of FIG. 5, it is assumed that two images (an image 500 and an image 501) have been shot with the ISO sensitivity=200 in the multi-shot NR mode. The system control circuit 50 generates a composite image 502 by compositing the image 500 and the image 501 in equal proportion. In general, if two images that have been shot with the same ISO sensitivity are combined, then the noise will be multiplied by (√(½)). Therefore, image compositing processing in the multi-shot NR mode fulfills the role of noise reduction (NR) processing.

### <Image Compositing Processing>

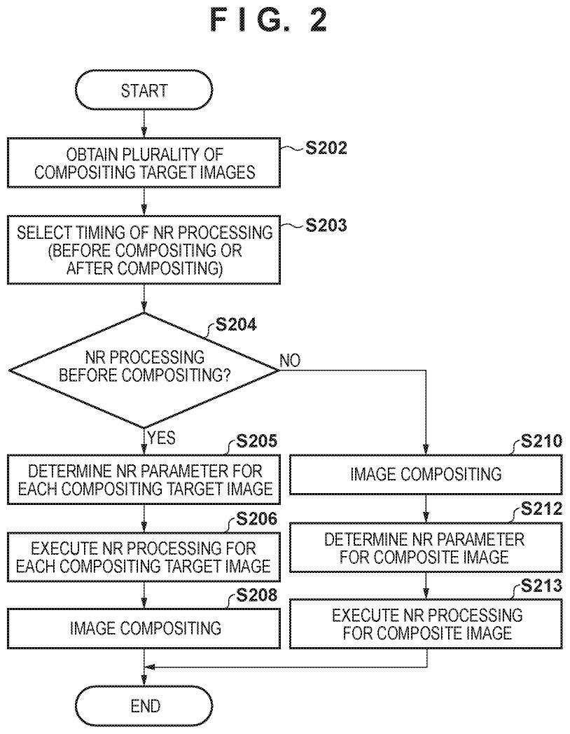

FIG. 2 is a flowchart showing image compositing processing executed by the image capturing apparatus 100 according to the first embodiment. Processing of each step of the present flowchart is realized by the system control circuit 50 deploying programs recorded in the nonvolatile memory 56 to a working area of the memory 52 and executing the programs, unless specifically stated otherwise.

Processing of the present flowchart is started upon completion of shooting in a shooting mode that accompanies the image compositing processing (e.g., the above-described HDR mode, multiple exposure mode, focus bracket mode, or multi-shot NR mode). Furthermore, processing of the present flowchart is started also when the user has selected an image compositing method and a plurality of compositing target images and instructed the system control circuit 50 to execute compositing (e.g., when the user has performed an operation of issuing an instruction for the image compositing processing that has been described with reference to FIG. 4) by operating the operation unit 66.

In step S202, the system control circuit 50 obtains a plurality of compositing target images. For example, the system control circuit 50 obtains the image 500 and the image 501 from the memory 30 when processing of the present flowchart has been started in response to completion of shooting of the image 500 and the image 501 in the multi-shot NR mode.

In step S203, the system control circuit 50 selects (determines) “before compositing (before generation of a composite image)” or “after compositing (after generation of a composite image)” as a timing to execute the noise reduction processing (NR processing). Note that the NR processing mentioned here is different from image compositing that is executed in the multi-shot NR mode to reduce noise (NR compositing). That is to say, in the case of the multi-shot NR mode, while noise is reduced by the NR compositing, NR processing that is different from the NR compositing is further executed before or after the NR compositing.

Examples of a selection method (determination method) in step S203 include “a selection method based on the image compositing method”, “a selection method based on a shooting condition that influences the noise characteristic”, and “a selection method based on a user instruction”.

In “the selection method based on the image compositing method”, the system control circuit 50 determines whether the image compositing method used in generation of a composite image is an image compositing method that has a high possibility of generating a composite image including a plurality of areas with different noise characteristics. In order to execute highly accurate NR processing with respect to the composite image including the plurality of areas with different noise characteristics, it is necessary to make the content of the NR processing vary on an area-by-area basis. Making the content of the NR processing vary on an area-by-area basis leads to a relatively high processing cost (processing load). In this case, it is considered that it is more efficient to execute the NR processing with respect to each individual compositing target image before compositing (before generation of the composite image) than to execute the NR processing with respect to the composite image after compositing (after generation of the composite image). In view of this, when the image compositing method that has a high possibility of generating the composite image including the plurality of areas with different noise characteristics (a first image compositing method) is used, the system control circuit 50 selects “before compositing” as a timing of the NR processing. Conversely, the NR processing can be executed at a relatively low processing cost (processing load) with respect to a composite image with a uniform noise characteristic. In this case, it is considered that it is more efficient to execute the NR processing with respect to the composite image after compositing than to execute the NR processing with respect to each individual compositing target image before compositing. In view of this, when an image compositing method that has a low possibility of generating a composite image including a plurality of areas with different noise characteristics (a second image compositing method) is used, the system control circuit 50 selects “after compositing” as a timing of the NR processing.

For example, when executing compositing processing for bringing a partial area of a specific image to the front layer of another image, which has been described with reference to FIG. 4, there is a high possibility that the composite image includes two areas with different noise characteristics. Therefore, the system control circuit 50 selects “before compositing” as a timing of the NR processing. Furthermore, also when an image compositing method corresponding to the HDR mode (an image compositing method for extending a dynamic range) and an image compositing method corresponding to the multiple exposure mode (an image compositing method for generating a multiple exposure image) are used, it is considered that there is a high possibility that a composite image including a plurality of areas with different noise characteristics is generated. Therefore, the system control circuit 50 selects “before compositing” as a timing of the NR processing.

Furthermore, for example, when an image compositing method corresponding to the multi-shot NR mode (an image compositing method for reducing noise) that has been described with reference to FIG. 5 is used, it is considered that there is a high possibility that a composite image with a uniform noise characteristic is generated. In the example of FIG. 5, as stated earlier, noise is multiplied by (√(½)) as a result of the NR compositing. Therefore, when executing the NR processing with respect to a composite image, it is possible to apply an NR parameter (an NR parameter for the ISO sensitivity=100) that is one level below an NR parameter for the compositing target images (the ISO sensitivity=200) in terms of the ISO sensitivity. In view of this, the system control circuit 50 selects “after compositing” as a timing of the NR processing. Furthermore, also when an image compositing method corresponding to the focus bracket mode (an image compositing method for performing depth compositing) is used, it is considered that there is a high possibility that a composite image with a uniform noise characteristic is generated. Therefore, the system control circuit 50 selects “after compositing” as a timing of the NR processing.

Note that in a case where a specific image compositing method is associated with a shooting mode, like in the case of the HDR mode for example, an image compositing method is also uniquely specified when a shooting mode has been specified. In this case, selection of a timing of the NR processing based on a shooting mode technically yields the same result as selection of a timing of the NR processing based on an image compositing method. Therefore, in a case where a specific image compositing method is associated with a shooting mode, selection of a timing of the NR processing based on a shooting mode is also encompassed in the range of “the selection method based on the image compositing method” described above.

In “the selection method based on a shooting condition that influences the noise characteristic”, the system control circuit 50 selects a timing of the NR processing based on shooting conditions that were used when respectively shooting the plurality of compositing target images, and that influence the noise characteristic of each of the plurality of compositing target images. Hereinafter, it is assumed that the ISO sensitivity is used as an example of the shooting condition that influences the noise characteristic.

When the shooting condition (ISO sensitivity) that influences the noise characteristic is different among the plurality of compositing target images, it is considered that there is a high possibility that a composite image including a plurality of areas with different noise characteristics is generated. Therefore, the system control circuit 50 selects “before compositing” as a timing of the NR processing.

Conversely, when the shooting condition (ISO sensitivity) that influences the noise characteristic is the same among a plurality of compositing target images, it is considered that there is a high possibility that a composite image with a uniform noise characteristic is generated. Therefore, the system control circuit 50 selects “after compositing” as a timing of the NR processing.

In “the selection method based on a user instruction”, the system control circuit 50 selects a timing of the NR processing in accordance with a user instruction. The user can instruct the system control circuit 50 to display a selection screen for selecting a timing of the NR processing on the image display unit 28 by operating the operation unit 66 in advance, and select a timing on the selection screen. Alternatively, the system control circuit 50 may display the selection screen on the image display unit 28 when processing of step S203 is executed.

In step S204, the system control circuit 50 determines whether the timing of the NR processing selected in step S203 is “before compositing”. In the case of “before compositing”, the processing flow proceeds to step S205, and otherwise, the processing flow proceeds to step S210.

In step S205, with respect to each of the plurality of compositing target images, the system control circuit 50 determines an NR parameter based on at least one of the shooting mode, the exposure condition (ISO sensitivity), the focusing distance, a subject, and a user instruction. For example, the memory 52 may hold NR parameters for respective ISO sensitivities, and the system control circuit 50 may select an NR parameter corresponding to the ISO sensitivity at the time of shooting for each compositing target image. Note that when it is known in advance that all compositing target images have been shot with the same ISO sensitivity, the system control circuit 50 may determine to select an NR parameter with respect to one compositing target image and use the same NR parameter for other compositing target images.

In step S206, the system control circuit 50 executes the NR processing with use of the NR parameter determined in step S205 with respect to each of the plurality of compositing target images. The NR processing mentioned here is not limited in particular, and may be, for example, NR processing that uses a bilateral filter.

In step S208, the system control circuit 50 generates a composite image by compositing the plurality of compositing target images for which the NR processing of step S206 has already been executed. The aforementioned variety of methods are possible as an image compositing method. Note that the system control circuit 50 may carry out the compositing after performing a position alignment among the compositing target images as necessary.

As stated earlier, when the timing of the NR processing is “after compositing”, the processing flow proceeds from step S204 to step S210. In step S210, the system control circuit 50 generates a composite image by compositing the plurality of compositing target images, similarly to step S208. However, unlike step S208, processing that is equivalent to the NR processing of step S206 has not been executed with respect to the plurality of compositing target images used in step S210.

In step S212, the system control circuit 50 determines an NR parameter for the composite image. The content of this processing is basically the same as step S205, and for example, it is permissible to adopt a configuration in which NR parameters for respective ISO sensitivities are held in the memory 52, and an NR parameter corresponding to an ISO sensitivity corresponding to the noise characteristic of the composite image is selected.

In step S213, the system control circuit 50 executes the NR processing with respect to the composite image with use of the NR parameter determined in step S212.

### Summary of First Embodiment

As described above, according to the first embodiment, the image capturing apparatus 100 generates a composite image by compositing a plurality of images (step S208 or S210). Also, the image capturing apparatus 100 selects one of a first noise reduction procedure (steps S205 and S206) for executing noise reduction processing with respect to each of the plurality of images before generation of the composite image, and a second noise reduction procedure (steps S212 and S213) for executing noise reduction processing with respect to the composite image after generation of the composite image (step S203). The image capturing apparatus 100 executes one of the first noise reduction procedure and the second noise reduction procedure in accordance with a result of this selection.

In this way, the first embodiment makes it possible to select whether to execute the NR processing before compositing or after compositing in a situation where a composite image is generated by compositing a plurality of images.

A selection method (selection criterion) for selecting one of the first noise reduction procedure and the second noise reduction procedure is not limited in particular. Examples of the selection method include the aforementioned “selection method based on the image compositing method”, “selection method based on a shooting condition that influences the noise characteristic”, and “selection method based on a user instruction”. For example, the first noise reduction procedure can be selected when there is a high possibility that a composite image including a plurality of areas with different noise characteristics is generated, and the second noise reduction procedure can be selected when there is a low possibility that a composite image including a plurality of areas with different noise characteristics is generated, and in this way, the NR processing can be performed more efficiently and the processing time period can be reduced.

### Second Embodiment

In the first embodiment, NR processing that uses a bilateral filter is used as an example of NR processing. On the other hand, a second embodiment will be described in relation to a case where NR processing based on deep learning technology (DL technique) that uses a neural network (DLNR processing) is executed. In the second embodiment, the basic configuration of the image capturing apparatus 100 is similar to that of the first embodiment. The following mainly describes the differences from the first embodiment.

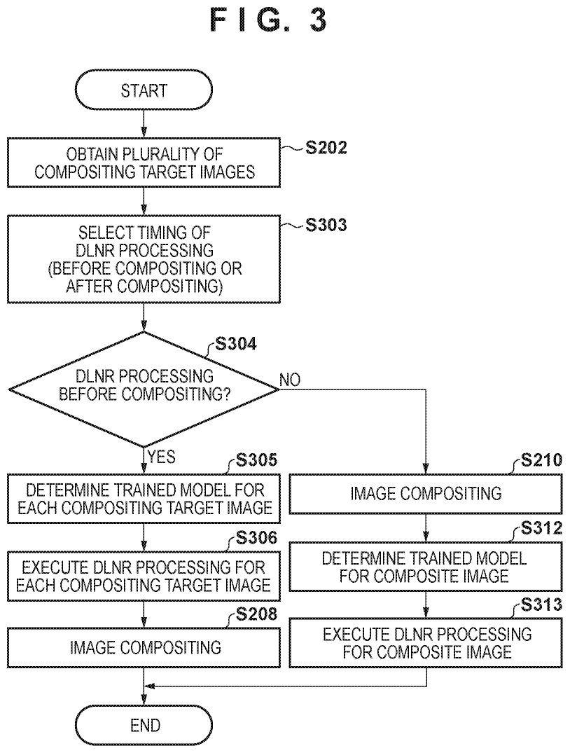

FIG. 3 is a flowchart showing image compositing processing executed by the image capturing apparatus 100 according to the second embodiment. Processing of each step of the present flowchart is realized by the system control circuit 50 deploying programs recorded in the nonvolatile memory 56 to a working area of the memory 52 and executing the programs, unless specifically stated otherwise.

Processing of the present flowchart is started upon completion of shooting in a shooting mode that accompanies the image compositing processing (e.g., the above-described HDR mode, multiple exposure mode, focus bracket mode, or multi-shot NR mode). Furthermore, processing of the present flowchart is started also when the user has selected a plurality of compositing target images and an image compositing method and instructed the system control circuit 50 to execute compositing (e.g., when the user has performed an operation of issuing an instruction for the image compositing processing that has been described with reference to FIG. 4) by operating the operation unit 66.

In step S303, the system control circuit 50 selects (determines) “before compositing (before generation of a composite image)” or “after compositing (after generation of a composite image)” as a timing to execute the DLNR processing. This processing is similar to step S203 of FIG. 2, except that this is processing for the “DLNR processing”.

In step S304, the system control circuit 50 determines whether the timing of the DLNR processing selected in step S303 is “before compositing”. In the case of “before compositing”, the processing flow proceeds to step S305, and otherwise, the processing flow proceeds to step S210.

In step S305, with respect to each of the plurality of compositing target images, the system control circuit 50 determines a model that has been trained in advance (a trained model) to be used in the DLNR processing. For example, it is permissible to adopt, as a configuration for making this determination, a configuration in which trained models for respective ISO sensitivities are held in the memory 52 and a trained model corresponding to the ISO sensitivity at the time of shooting is selected for each compositing target image.

In step S306, the system control circuit 50 executes the DLNR processing with use of the trained model determined in step S305 with respect to each of the plurality of compositing target images.

In step S312, the system control circuit 50 determines a trained model for the composite image. The content of this processing is basically the same as step S305, and for example, it is permissible to adopt a configuration in which trained models for respective ISO sensitivities are held in the memory 52, and a trained model corresponding to an ISO sensitivity corresponding to the noise characteristic of the composite image is selected.

In step S313, the system control circuit 50 executes the DLNR processing with respect to the composite image with use of the trained model determined in step S312.

In general, the DLNR processing requires a longer processing time period than other types of NR processing (e.g., NR processing that uses a bilateral filter, which has been exemplarily described in the first embodiment). Therefore, in the second embodiment that uses the DLNR processing, the efficiency of the DLNR processing can be further increased and the processing time period can be reduced by selecting a timing of the DLNR processing with use of a method similar to that of the first embodiment.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-068348, filed Apr. 17, 2025, which is hereby incorporated by reference herein in its entirety.

What is claimed is:

1. An image processing apparatus comprising at least one processor and/or at least one circuit which functions as:
a generation unit configured to generate a composite image by compositing a plurality of images;
a selection unit configured to select one of a first noise reduction procedure and a second noise reduction procedure, wherein the first noise reduction procedure executes noise reduction processing on each of the plurality of images before generation of the composite image, and the second noise reduction procedure executes noise reduction processing on the composite image after generation of the composite image; and
a noise reduction unit configured to execute one of the first noise reduction procedure and the second noise reduction procedure in accordance with a result of the selection.

2. The image processing apparatus according to claim 1, wherein
the selection unit selects one of the first noise reduction procedure and the second noise reduction procedure based on an image compositing method used to generate the composite image.

3. The image processing apparatus according to claim 2, wherein
the selection unit selects the first noise reduction procedure in a case where the image compositing method is a first image compositing method, and selects the second noise reduction procedure in a case where the image compositing method is a second image compositing method, and
in a case where the composite image is generated using the first image compositing method, a possibility that the composite image includes a plurality of areas with different noise characteristics is higher than in a case where the composite image is generated using the second image compositing method.

4. The image processing apparatus according to claim 2, wherein
the selection unit selects the first noise reduction procedure in a case where the image compositing method is an image compositing method for extending a dynamic range.

5. The image processing apparatus according to claim 2, wherein
the selection unit selects the first noise reduction procedure in a case where the image compositing method is an image compositing method for generating a multiple exposure image.

6. The image processing apparatus according to claim 2, wherein
the selection unit selects the second noise reduction procedure in a case where the image compositing method is an image compositing method in which depth compositing is performed.

7. The image processing apparatus according to claim 2, wherein
the selection unit selects the second noise reduction procedure in a case where the image compositing method is an image compositing method for reducing noise.

8. The image processing apparatus according to claim 1, wherein
the selection unit selects one of the first noise reduction procedure and the second noise reduction procedure based on shooting conditions used when respectively shooting the plurality of images and influencing a noise characteristic of each of the plurality of images.

9. The image processing apparatus according to claim 8, wherein
the selection unit selects the first noise reduction procedure in a case where the shooting conditions are different among the plurality of images, and selects the second noise reduction procedure in a case where the shooting conditions are the same among the plurality of images.

10. The image processing apparatus according to claim 8, wherein
the shooting conditions are ISO sensitivities.

11. The image processing apparatus according to claim 1, wherein
the selection unit selects one of the first noise reduction procedure and the second noise reduction procedure based on an instruction from a user.

12. The image processing apparatus according to claim 1, wherein
in a case where the first noise reduction procedure is executed, the noise reduction unit determines a parameter to be used in the noise reduction processing for each of the plurality of images.

13. The image processing apparatus according to claim 1, wherein
the noise reduction processing is noise reduction processing that is based on deep learning technology, and
in a case where the first noise reduction procedure is executed, the noise reduction unit determines a trained model to be used in the noise reduction processing for each of the plurality of images.

14. An image capturing apparatus, comprising:
the image processing apparatus according to claim 1; and
an image sensor configured to shoot the plurality of images.

15. An image processing method executed by an image processing apparatus, comprising:
generating a composite image by compositing a plurality of images;
selecting one of a first noise reduction procedure and a second noise reduction procedure, wherein the first noise reduction procedure executes noise reduction processing on each of the plurality of images before generation of the composite image, and the second noise reduction procedure executes noise reduction processing on the composite image after generation of the composite image; and
executing one of the first noise reduction procedure and the second noise reduction procedure in accordance with a result of the selection.

16. A non-transitory computer-readable storage medium which stores a program for causing a computer to execute an image processing method comprising:
generating a composite image by compositing a plurality of images;
selecting one of a first noise reduction procedure and a second noise reduction procedure, wherein the first noise reduction procedure executes noise reduction processing on each of the plurality of images before generation of the composite image, and the second noise reduction procedure executes noise reduction processing on the composite image after generation of the composite image; and
executing one of the first noise reduction procedure and the second noise reduction procedure in accordance with a result of the selection.
